(19) United States
(12) Patent Application Publication
(10) Pub. No.: US 2022/0240177 A1
(43) Pub. Date: Jul. 28, 2022

(54) METHOD OF SETTING RECEPTION PERIOD OF REPEATER, COMMUNICATION SYSTEM, AND REPEATER

(71) Applicant: SHARP KABUSHIKI KAISHA, Sakai City (JP)

(72) Inventors: Takumi NISHINA, Sakai City (JP); TOMOHISA YOSHIE, Sakai City (JP); Yuki KYODA, Sakai City (JP); MASATO SASAKI, Sakai City (JP); SATOSHI SHIMIZU, Sakai City (JP); DAISUKE TOYOSHIMA, Sakai City (JP)

(21) Appl. No.: 17/569,806

(22) Filed: Jan. 6, 2022

(30) Foreign Application Priority Data
Jan. 25, 2021 (JP) 2021-009662

(51) Int. Cl. H04W 52/02; H04W 76/28; H04W 72/12

(52) U.S. Cl. CPC H04W 52/0203; H04W 72/1257; H04W 76/28

(57) ABSTRACT

The present disclosure provides technology of setting the reception period of a repeater or the transmission period of a transmitter. The present disclosure provides a method of setting the reception period of a repeater 100 including a battery 120 and configured to receive radio waves transmitted by at least one transmitter 200, the method including setting the reception period of the repeater 100 based on a power consumption Pk (Wh) of the at least one transmitter 200 and a power consumption Pc (Wh) of the repeater 100.

### CROSS-REFERENCE TO RELATED APPLICATIONS

The present application claims priority from Japanese Patent Application, Tokugan, No. 2021-009662 filed on Jan. 25, 2021, the content of which is hereby incorporated by reference into this application.

### FIELD OF THE INVENTION

The present disclosure relates to technology of setting the reception period of a repeater for receiving radio waves from a transmitter.

### BACKGROUND OF THE INVENTION

Communication systems have been known that include a transmitter and a repeater for receiving radio waves from a transmitter. For instance, Japanese Unexamined Patent Application Publication, Tokukai, No. 2018-152047 discloses a sensor device. The sensor device of Japanese Unexamined Patent Application Publication, Tokukai, No. 2018-152047 includes: a sensor unit for detecting environmental information; a sensor device communication unit for transmitting the detected environmental information to another sensor device; a primary battery for supplying electric power to the sensor unit and the sensor device communication unit; and a sensor-device coupler section for detachably attaching an auxiliary battery for supplying electric power to the sensor device. When there is no auxiliary battery attached to the sensor device, the sensor device operates on the primary battery; when there is an auxiliary battery attached, the sensor device operates on either the primary battery or the auxiliary battery. The sensor device communication unit is capable of further transmitting information on the battery voltage or information on the auxiliary battery voltage to another sensor device.

Japanese Unexamined Patent Application Publication, Tokukai, No. 2011-13765 discloses a sensor network system. The sensor network system of Japanese Unexamined Patent Application Publication, Tokukai, No. 2011-13765 includes: sensor network terminals having a wireless communication function and individually driven by an environmental generator; and a system manager connected to any of the sensor network terminals via a wired link. Each sensor network terminal includes: means for detecting the amount of power generated by the environmental generator connected to the sensor network terminal and further detecting the charged capacity of the environmental generator; means for transmitting the detected amount of power generated and the detected charged capacity to the system manager; and means for changing a measurement period setting on the basis of a measurement period transmitted from the system manager. The system manager includes: means for computing a measurement period of the sensor network terminal on the basis of an amount of power generated and a charged capacity both obtained from the sensor network terminal; and means for transmitting results of the computation as value settings to the sensor network terminal.

### SUMMARY OF THE INVENTION

### Problems to be Solved by the Invention

The present disclosure has an object to provide technology of more efficiently setting the reception period of a repeater or the transmission period of a transmitter.

### Solution to the Problems

The present disclosure, in an aspect thereof, provides a method of setting the reception period of a repeater that includes a battery and that receives radio waves transmitted by one or more transmitters, thereby setting the reception period of the repeater on the basis of the power consumption Pk (Wh) of the one or more transmitters and the power consumption Pc (Wh) of the repeater.

### Advantageous Effects of the Invention

As described in the foregoing, the present disclosure enables setting the reception period of a repeater or the transmission period of a transmitter.

### BRIEF DESCRIPTION OF DRAWINGS

FIG. 1 is a block diagram of an entire communication system 1 including one repeater 100 and one transmitter 200 in accordance with a first embodiment.

FIG. 2 is a block diagram of the entire communication system 1 including one repeater 100 and a plurality of transmitters 200 in accordance with the first embodiment.

FIG. 3 is a block diagram of a structure of the repeater 100 in accordance with the first embodiment.

FIG. 4 is a diagram depicting a transmission period and a reception period in accordance with the first embodiment.

FIG. 5 is a graph representing the power consumption of each device and the total power consumption in accordance with the first embodiment.

FIG. 6 is a flow chart representing a process performed by the repeater 100 in accordance with the first embodiment.

FIG. 7 is a block diagram of a structure of a repeater 100 in accordance with a second embodiment.

FIG. 8 is a flow chart representing a process performed by the repeater 100 in accordance with the second embodiment.

FIG. 9 is a graph representing a correlation between objective functions f(x) and g(x) in accordance with a third embodiment.

FIG. 10 is a flow chart representing a process performed by a repeater 100 in accordance with the third embodiment.

FIG. 11 is a flow chart representing a process performed by a repeater 100 in accordance with a fourth embodiment

FIG. 12 is a table of various parameters of a repeater 100 and a transmitter 200 in accordance with a fifth embodiment.

FIG. 13 is a table representing a correlation between the transmission period and the power consumption of the transmitter 200 for different reception periods of the repeater 100 in a communication system 1 including one repeater 100 and one transmitter 200 in accordance with the fifth embodiment.

FIG. 14 is a table representing a preferable correlation between the reception period of the repeater 100 and the transmission period of the transmitter 200 in the communication system 1 including one repeater 100 and one transmitter 200 in accordance with the fifth embodiment.

FIG. 15 is a table representing a correlation between the transmission period and the power consumption of each transmitter 200 for different reception periods of the repeater 100 in a communication system 1 including one repeater 100 and a plurality of transmitters 200 in accordance with the fifth embodiment.

FIG. 16 is a table representing a preferable correlation between the reception period of the repeater 100 and the transmission period of each transmitter 200 in the communication system 1 including one repeater 100 and a plurality of transmitters 200 in accordance with the fifth embodiment.

### DESCRIPTION OF EMBODIMENTS

The following will describe an embodiment of the present disclosure with reference to drawings. Identical members are denoted by the same reference numerals throughout the following description. Such members are given the same names and have the same functionality, and description thereof is therefore not repeated.

### First Embodiment

### Overall Structure of Communication System 1

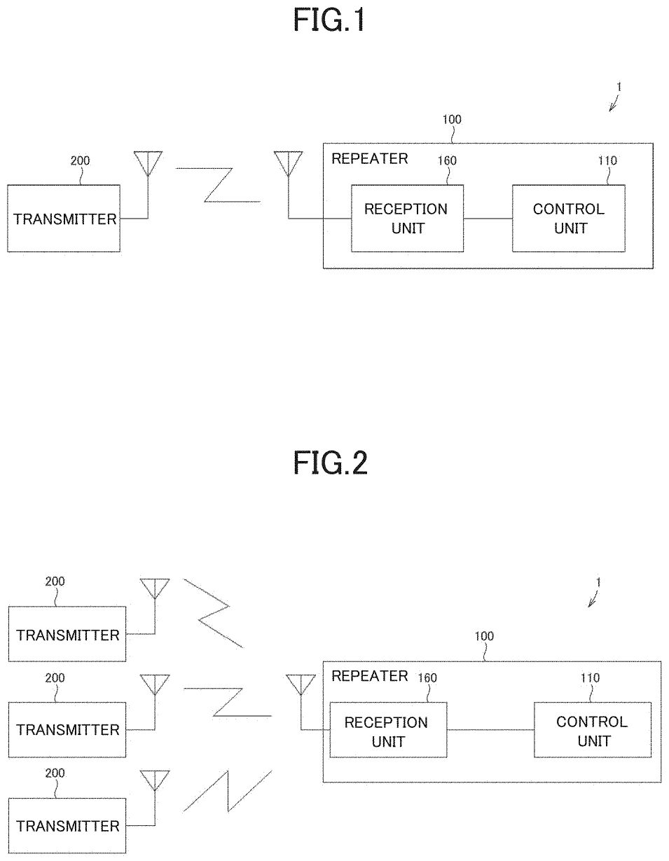

A description is given first of an overall structure of a communication system 1 in accordance with the present embodiment. The communication system 1 may, for example, include either one transmitter 200 for each repeater 100 as shown in FIG. 1 or a plurality of transmitters 200 for each repeater 100 as shown in FIG. 2. The transmitter or transmitters 200 transmit(s) data including various information from a wireless antenna, so that the repeater 100 can receive and store the data and transmit the data to, for example, another like device or a server.

### Structure of Repeater 100

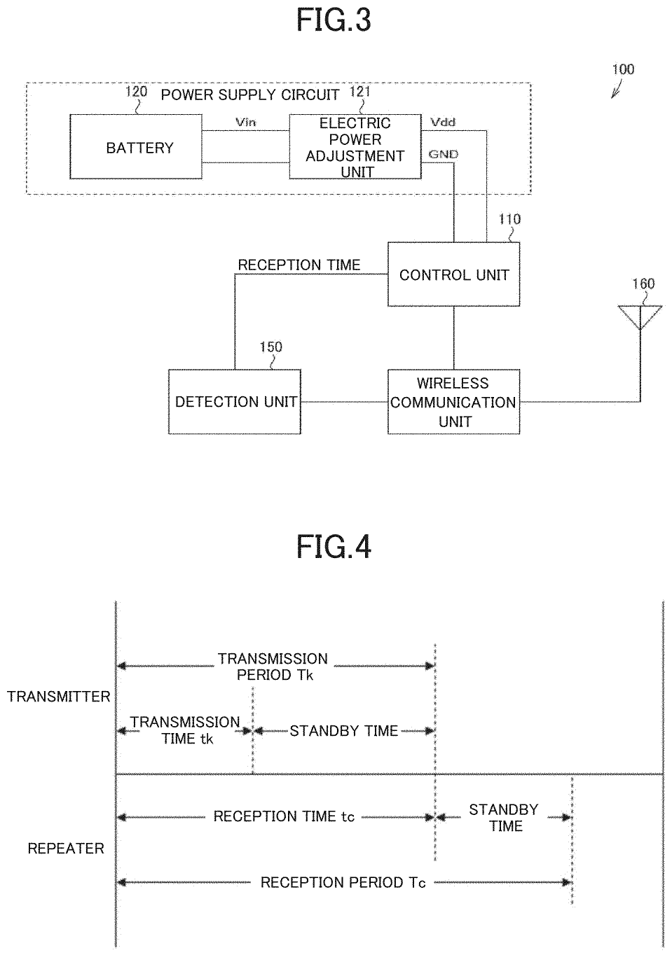

A description is given next of a structure of the repeater 100. Referring to, for example, FIG. 3, the repeater 100 includes a control unit 110, a battery 120, an electric power adjustment unit 121, a detection unit 150, and a reception unit 160 that is built, for example, around a wireless communication antenna.

The control unit 110 drives the reception unit 160 on the electric power provided by the battery 120. The control unit 110 receives data from the transmitter 200 via the reception unit 160, for example, to store the data in a memory in the control unit 110 and transmit the data to another device such as a server.

In the present embodiment, the control unit 110, for example, activates the reception unit 160 once every reception period Tc to receive data and deactivates the reception unit 160 when a reception time tc elapses, by using the detection unit 150, as shown in FIG. 4.

Particularly in the present embodiment, the control unit 110 is configured to reduce either the power consumption of the repeater 100 or the power consumption of the transmitter 200 or the sum of both by the control method described in the following.

### Structure of Transmitter 200

The transmitter 200 has the same structure as the repeater 100, and description thereof is not repeated in this embodiment. For instance, the transmitter 200 includes a control unit 110 that, for example, activates the reception unit 160 once every transmission period Tk to transmit data and deactivates the reception unit 160 when a transmission time tk elapses, by using the detection unit 150, as shown in FIG. 4.

### Method of Determining Reception Period for Repeater 100

A description is given now of method of determining a reception period for the repeater 100 in accordance with the present embodiment. First, the following are formulas from which the power consumption of the transmitter 200 and the power consumption of the repeater 100 are derived respectively.

Pk={Qk Tk+(Rk−Qk)*tk{*3600/Tk] (1)

Pk: power consumption of transmitter (Wh)

Qk: standby power consumption (constant)

Rk: transmission power consumption (constant)

tk: transmission time (sec.)

Tk: transmission period (sec.)

Pc={(Rc−Qc)*Tk+Qc Tc}*3600/Tc (2)

Pc: power consumption of repeater (Wh)

Qc: standby power consumption (constant)

Rc: reception power consumption (constant)

tc (Tk): reception time (period of transmitter) (sec.)

Tc: reception period (sec.)

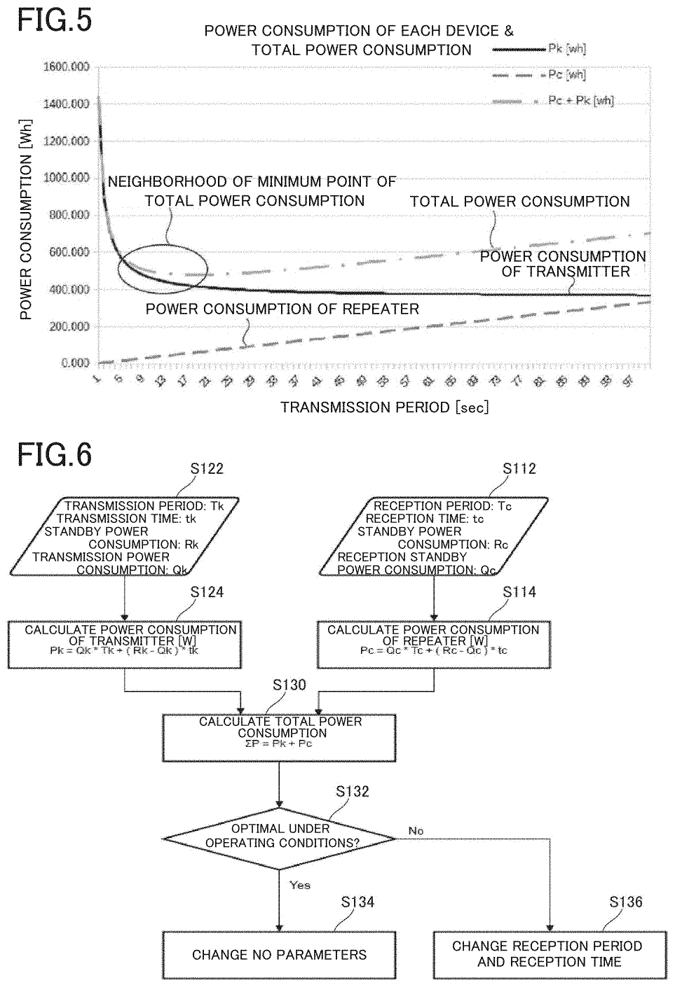

FIG. 5 is a graph obtained by plugging in the actual reception and standby power consumptions of the repeater 100 and the actual transmission and standby power consumptions of the transmitter 200. More particularly, FIG. 5 is a graph prepared by plugging the actual reception and standby power consumptions of the repeater 100 and the actual transmission and standby power consumptions of the transmitter 200 into formulas (1) and (2) respectively under the following conditions:

The transmission time of the transmitter is fixed to 1 second;

The transmission period of the transmitter is varied in the range of 1 second to 200 seconds;

The reception period of the repeater is fixed to 600 seconds (10 minutes);

Qk=0.1 (W);

Rk=0.4 (W);

Qc=0.000021 (W); and

Rc=0.557 (W).

In FIG. 5, the solid line indicates the power consumption of the transmitter 200, the dotted line indicates the power consumption of the repeater 100, and the dash-dot line indicates the total power consumption of the repeater 100 and the transmitter 200.

This graph shows that:

(1) The power consumption of the transmitter 200, the power consumption of the repeater 100, and the total power consumption change with the transmission period of the transmitter 200;

(2) The power consumptions decrease with an increase in the transmission period;

(3) In the repeater, the power consumption increases with an increase in the transmission period. The power consumption of the repeater is approximately 55 times smaller in the neighborhood of the minimum point than when the repeater is constantly on standby for reception;

(4) From these phenomena, the total power consumption will be significantly reduced by reducing the reception time of the repeater and increasing the transmission period of the transmitter; and

(5) In the present embodiment, the total power consumption of the transmitter 200 and the repeater 100 takes a minimum value when the transmitter has a transmission period of approximately 11 seconds.

When there is provided a plurality of transmitters 200, the repeater 100 requires a minimum reception time that is equal to the sum of the transmission periods of the transmitters 200, and the repeater 100 has an optimal reception time that is equal to the sum of the optimal reception times of the transmitters 200.

The description so far demonstrates that the minimum value of the total power consumption under current conditions can be calculated by calculating, for example, the power consumption of the repeater 100 for the reception period thereof under current conditions and the power consumption of the transmitter 200 for the transmission period thereof under current conditions.

### Process of Setting Reception Period of Repeater 100

A description is given next of the information processing performed by the control unit 110 in the repeater 100 in accordance with the present embodiment with reference to FIG. 6. First, the control unit 110, for example, retrieves or acquires the current reception period Tc and the current reception time to from the memory or the detection unit 150 (step S112). The control unit 110, for example, further retrieves or acquires the standby power consumption Rc and the reception standby power consumption Qc of the battery 120 from the memory or the electric power adjustment unit 121 (step S112).

The control unit 110 then calculates the power consumption Pc (Wh) of the repeater from formula (2) as described earlier (step S114).

The control unit 110, for example, retrieves or acquires the transmission period Tk and the reception time tk of the transmitter 200 from the memory or the transmitter 200 via or not via the reception unit 160 (step S122). The control unit 110, for example, further retrieves or acquires the standby power consumption Rc and the reception standby power consumption Qc of the battery 120 from the memory or the electric power adjustment unit 121 (step S122).

The control unit 110 then calculates the power consumption Pk (Wh) of the transmitter from formula (1) as described earlier (step S124).

The control unit 110 calculates the total power consumption ΣP=Pk+Pc (step S130).

The control unit 110 determines whether or not the total power consumption is low under current conditions on the basis of the graph in FIG. 5 under current conditions (step S132).

If the total power consumption is relatively low under current conditions (YES in step S132), the control unit 110 changes no parameters, that is, continues the current operation (step S134).

If the total power consumption is relatively high under current conditions (NO in step S132), the control unit 110 changes for example, the reception period and the reception time in such a manner as to reduce the total power consumption (step S136). The control unit 110 repeats these steps to adjust the reception period of the repeater 100 to an optimal value.

### Second Embodiment

The repeater 100 includes the battery 120 in the foregoing embodiment. In the present embodiment, the repeater 100 includes an environmental generation unit 225.

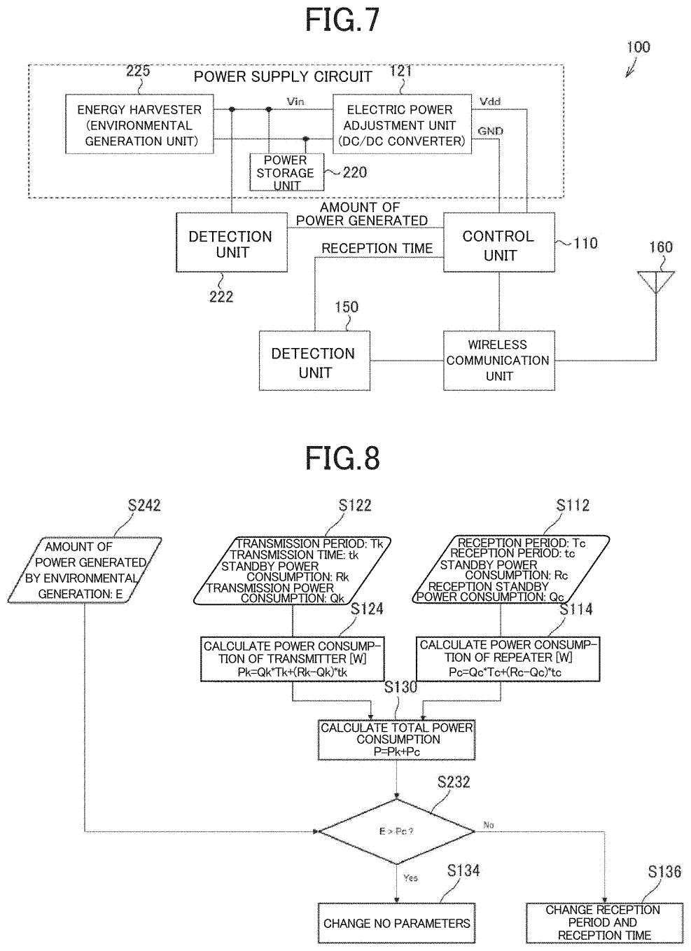

More particularly, referring to FIG. 7, the repeater 100 includes a control unit 110, a storage battery 220, an electric power adjustment unit 121, a second detection unit 222, a detection unit 150, and a reception unit 160.

The environmental generation unit 225 may be an environmental generator, such as a solar cell, a piezoelectric generator, or a thermal power generator, that generates and stores electric power in the storage battery 220. The second detection unit 222 measures the amount of the power generated by the environmental generation unit 225. The control unit 110, for example, drives the reception unit 160 and sets the reception period of the reception unit 160 on the electric power provided by the storage battery 220.

A description is given now of the information processing performed by the control unit 110 in the repeater 100 in accordance with the present embodiment with reference to FIG. 8. Steps S112, S114, S122, S124, and S130 here are the same as those in the foregoing embodiment, and description thereof is not repeated.

The control unit 110 acquires the amount E of power generated by the environmental generation unit 225 from the second detection unit 222 (step S240).

The control unit 110 determines whether or not the amount E is larger than the total power consumption ΣP=Pk+Pc (step S232).

If the amount E is larger than the total power consumption under current conditions (YES in step S232), the control unit 110 changes no parameters, that is, continues the current operation (step S134).

If the total power consumption is larger than the amount of power generated under current conditions (NO in step S232), the control unit 110 changes, for example, the reception period and the reception time in such a manner as to reduce the total power consumption (step S136). The control unit 110 repeats these steps to maintain the total power consumption equal to or below the amount of power generated.

### Third Embodiment

The control unit 110 may perform multi-objective optimization to optimize the reception period. Formulas (1) and (2) described above are used again in the present embodiment. The same conditions as those in the foregoing embodiments are used as given below:

Qk=0.1 (W);

Rk=0.4 (W);

Qc=0.000021 (W); and

Rc=0.557 (W)

These conditions are plugged into formulas (1) and (2).

Pk=1080*tk/Tk+360

Pc=2005.2*Tk/Tc+0.0756

Multi-objective optimization that involves three variables and two objectives is performed on these two formulas as follows. The constraint functions may naturally vary with the operating environment of the repeater 100 and the transmitter 200.

X=Tk;

Y=tk;

Z=Tc;

Pk+Pc is minimized;

Pk=1080*Y/X+360;

Pc=2005.2*X/Z+0.0756;

Tc>Tk>tk>0; and

Objective functions are f(x)=Pk=1080*Y/X+360 and g(x)=Pc=2005.2*X/Z+0.0756

### Optimization is Done by NSGA-2 in the Present Embodiment

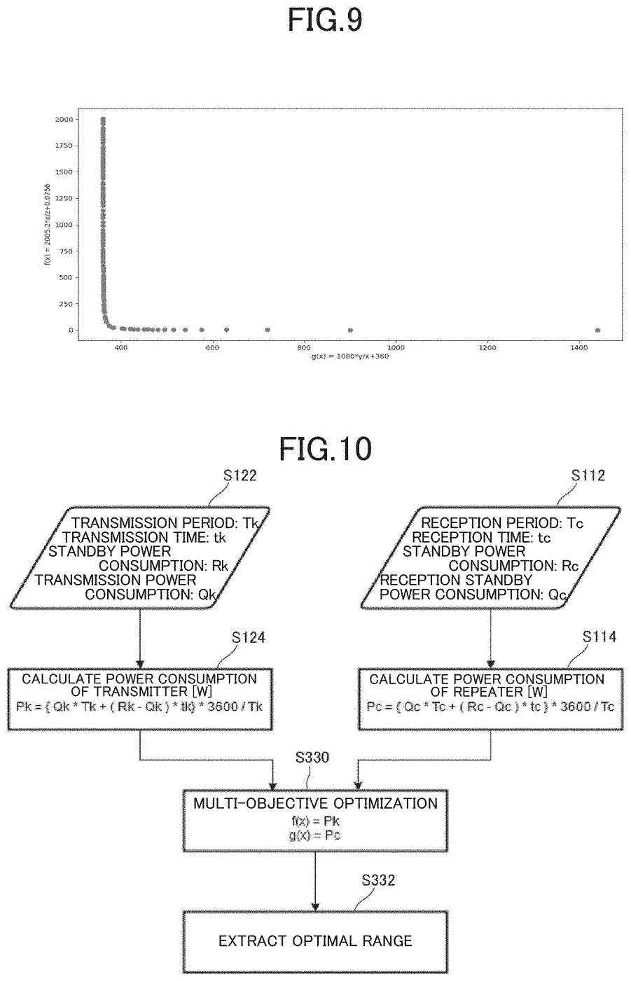

FIG. 9 shows results of the multi-objective optimization in accordance with the present embodiment.

X=Tk, Y=tk, and Z=Tc are thus determined that reduces the sum of the objective functions f(x) and g(x), that is, the total power consumption, under current conditions.

A description is given of the information processing performed by the control unit 110 in the repeater 100 in accordance with the present embodiment with reference to FIG. 10. Steps S112, S114, S122, and S124 here are the same as those in the foregoing embodiments, and description thereof is not repeated.

The control unit 110 generates objective functions f(x)=Pk and g(x)=Pc under current conditions to perform multi-objective optimization (step S330).

The control unit 110 determines the reception period Tc of the repeater 100 on the basis of the results of the optimization to set the reception period Tc again (step S332).

### Fourth Embodiment

In the foregoing embodiments, the reception period of the repeater 100 is determined based not only on the parameters of the repeater 100, but also on, for example, the transmission period 717k and the reception time tk of the transmitter 200. In contrast, the reception period of the repeater 100 is determined based primarily on the parameters of the repeater 100 in the present embodiment.

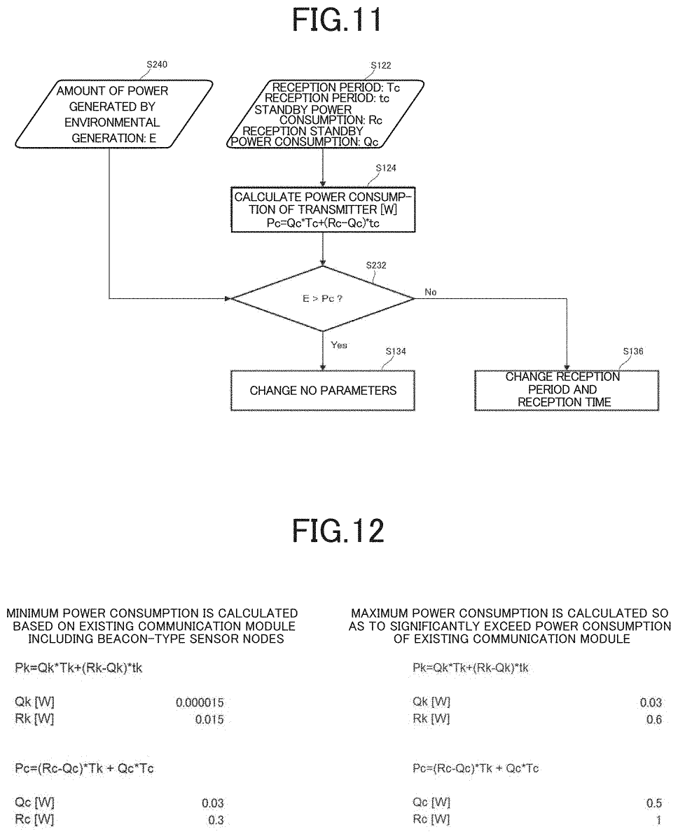

A description is given of the information processing performed by the control unit 110 in the repeater 100 in accordance with the present embodiment with reference to FIG. 11. First, the control unit 110, for example, retrieves or acquires the current reception period Tc and the current reception time tc from the memory or the detection unit 150 (step S112). The control unit 110, for example, further retrieves or acquires the standby power consumption Re and the reception standby power consumption Qc of the battery 120 from the memory or the electric power adjustment unit 121 (step S112).

The control unit 110 then calculates the power consumption Pk (Wh) of the transmitter from formula (1) as described earlier (step S114).

The control unit 110 acquires the amount E of power generated by the environmental generation unit 225 from the second detection unit 222 (step S240).

The control unit 110 determines whether or not the amount E is larger than the power consumption Pc of the repeater 100 (step S232).

If the amount E is larger than the power consumption Pc of the repeater 100 under current conditions (YES in step S232), the control unit 110 changes no parameters, that is, continues the current operation (step S134).

If the power consumption Pc of the repeater 100 is larger than the amount E of power generated under current conditions (NO in step S232), the control unit 110 changes, for example, the reception period and the reception time in such a manner as to educe the power consumption of the repeater 100 (step S136). The control unit 110 repeats these steps to maintain the total power consumption equal to or below the amount of power generated.

### Fifth Embodiment

A description is given of a configuration for setting the transmission period of the transmitter 200, first, in a communication system 1 including one repeater 100 and one transmitter 200.

The minimum value of the power consumption of the transmitter 200, the minimum value of the power consumption of the repeater 100, the maximum value of the power consumption of the transmitter 200, and the maximum value of the power consumption of the repeater 100 are calculated, as shown in FIG. 12.

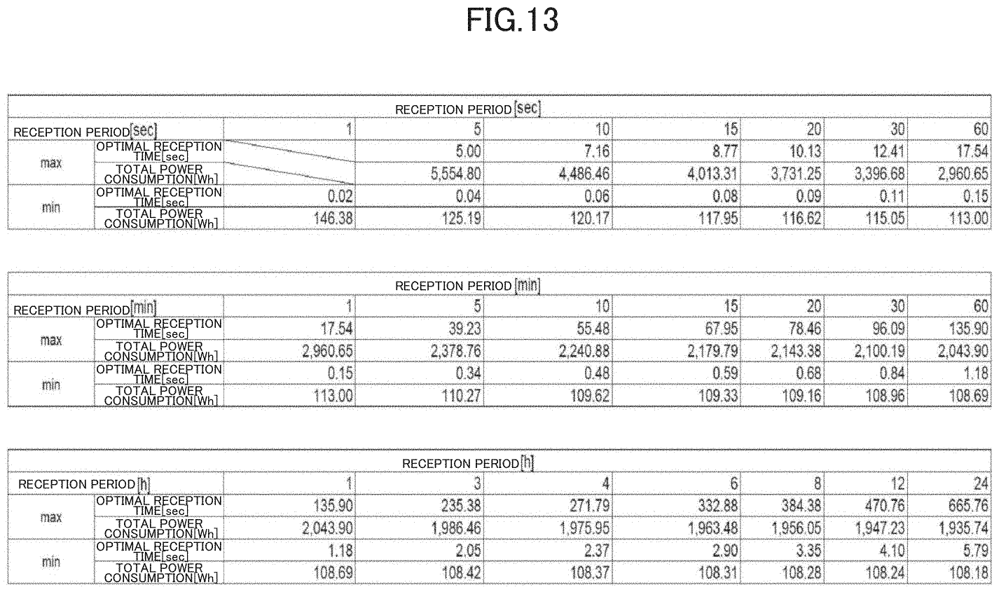

Using these values, the optimal reception time that minimizes the total power consumption of the transmitter 200 and the repeater 100, this minimum total power consumption, the optimal reception time that maximizes the total power consumption of the transmitter 200 and the repeater 100, and this maximum total power consumption are calculated for different reception periods of the repeater 100. FIG. 13 shows results of the calculation.

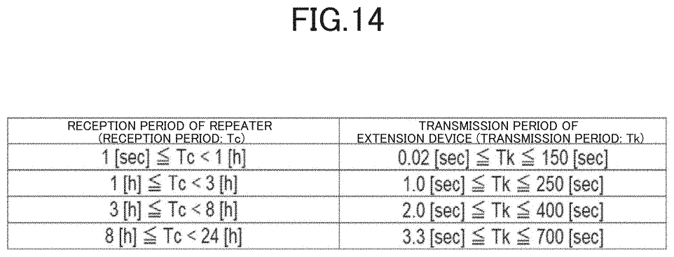

FIG. 13 demonstrates that there is a correlation between the reception period of the repeater 100 and the reception period of the transmitter 200 in the system including one repeater 100 and one transmitter 200. Referring to FIG. 14, (a) the transmission period of the transmitter is preferably set to from 3.3 seconds to 700 seconds, both inclusive, when the reception period of the repeater is from 8 hours inclusive to 24 hours exclusive; (b) the transmission period of the transmitter is preferably set to from 2.0 seconds to 400 seconds, both inclusive, when the reception period of the repeater is from 3 hours inclusive to 8 hours exclusive; (c) the transmission period of the transmitter is preferably set to from 1.0 seconds to 250 seconds, both inclusive, when the reception period of the repeater is from 1 hour inclusive to 3 hours exclusive; and (d) the transmission period of the transmitter is preferably set to from 0.02 seconds to 150 seconds, both inclusive, when the reception period of the repeater is from 1 second inclusive to 1 hour exclusive.

A description is given of a configuration for setting the transmission period of the transmitter 200, next, in a communication system 1 including one repeater 100 and ten transmitters 200.

The minimum value of the power consumption of the transmitter 200, the minimum value of the power consumption of the repeater 100, the maximum value of the power consumption of the transmitter 200, and the maximum value of the power consumption of the repeater 100 are calculated as shown in FIG. 14.

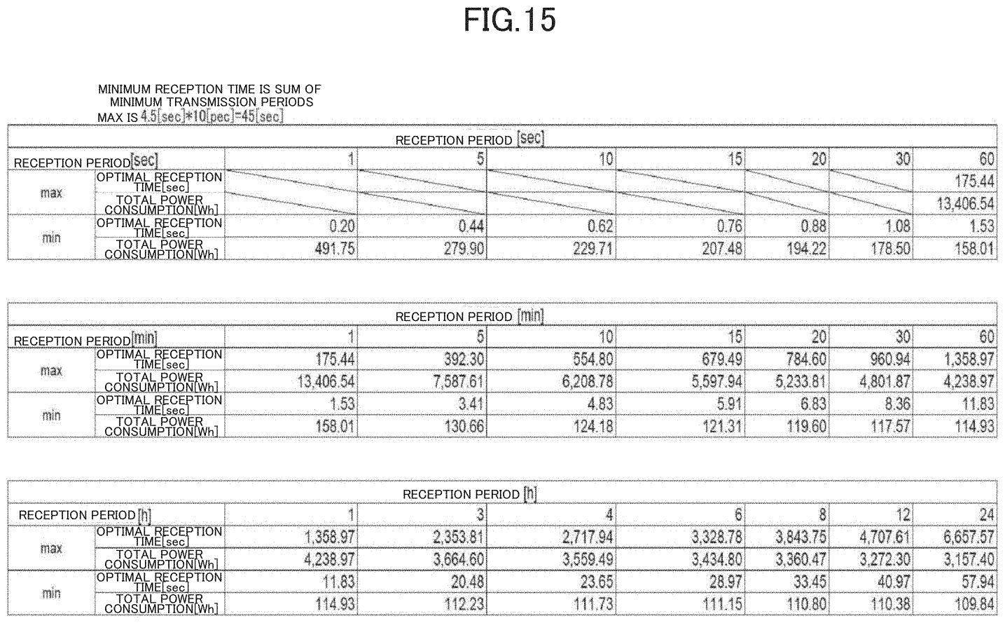

Using these values, the optimal reception time that minimizes the total power consumption of the transmitter 200 and the repeater 100, this minimum total power consumption, the optimal reception time that maximizes the total power consumption of the transmitter 200 and the repeater 100, and this maximum total power consumption are calculated for different reception periods of the repeater 100. FIG. 15 shows results of the calculation.

FIG. 15 demonstrates that there is a correlation between the reception period of the repeater 100 and the reception periods of the transmitters 200 in the system including one repeater 100 and ten transmitters 200. Referring to FIG. 17, (a) the transmission period of each transmitter is preferably set to from 33 seconds to 7,000 seconds, both inclusive, when the reception period of the repeater is from 8 hours inclusive to 24 hours exclusive; (b) the transmission period of each transmitter is preferably set to from 20 seconds to 4,000 seconds, both inclusive, when the reception period of the repeater is from 3 hours inclusive to 8 hours exclusive; (c) the transmission period of each transmitter is preferably set to from 10 seconds to 2,500 seconds, both inclusive, when the reception period of the repeater is from 1 hour inclusive to 3 hours exclusive; and (d) the transmission period of each transmitter is preferably set to from 0.2 seconds to 1,500 seconds, both inclusive, when the reception period of the repeater is from 1 second inclusive to 1 hour exclusive.

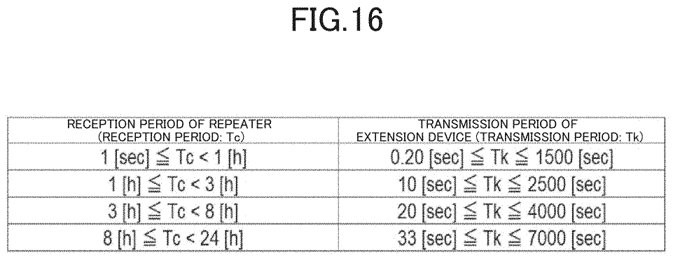

FIG. 16 demonstrates that there would be a correlation between the reception period of the repeater 100 and the reception periods of the transmitters 200 in the system including one repeater 100 and n transmitters 200: (a) the transmission period of each transmitter is preferably set to from 3.3×n seconds to 700×n seconds, both inclusive, when the reception period of the repeater is from 8 hours inclusive to 24 hours exclusive; (b) the transmission period of each transmitter is preferably set to from 2.0×n seconds to 400×n seconds, both inclusive, when the reception period of the repeater is from 3 hours inclusive to 8 hours exclusive; (c) the transmission period of each transmitter is preferably set to from 1.0×n seconds to 250×n seconds, both inclusive, when the reception period of the repeater is from 1 hour inclusive to 3 hours exclusive; and (d) the transmission period of each transmitter is preferably set to from 0.02×n seconds to 150×n seconds, both inclusive, when the reception period of the repeater is from 1 second inclusive to 1 hour exclusive.

The transmission period of the transmitter 200 may be set to the optimal value on the basis of these criteria by a worker acquiring the parameters related to the repeater 100 and the transmitter 200. Alternatively, the transmission period of the transmitter 200 may be automatically set to a value that suits the reception period of the repeater 100 by a control unit, for the transmitter 200, for example, receiving the reception period from the repeater 100 through a wireless communication antenna or receiving an input through an operation unit on how many transmitters 200 are provided for each repeater 100.

The embodiments disclosed herein are for illustrative purposes only in every respect and provide no basis for restrictive interpretations. The scope of the present disclosure is defined only by the claims and never bound by the foregoing description. Those modifications and variations that may lead to equivalents of claimed elements are all included within the scope of the disclosure.

What is claimed is:

1. A method of setting a reception period of a repeater including a battery and configured to receive radio waves transmitted by at least one transmitter, the method comprising setting the reception period based on a power consumption Pk (Wh) of the at least one transmitter and a power consumption Pc (Wh) of the repeater.

2. The method according to claim 1, wherein
the at least one transmitter comprises a plurality of transmitters, and
the reception period is set based on a total power consumption Pkn (Wh) of the plurality of transmitters and the power consumption Pc (Wh) of the repeater.

3. A communication system comprising:
n transmitters each including a first battery and configured to transmit radio waves with a prescribed transmission period, where n is an integer greater than or equal to 1; and
a repeater including a second battery and configured to receive the radio waves transmitted by the n transmitters with a reception period, wherein
(a) the transmission periods of the transmitters are set to from 3.3×n seconds to 700×n seconds, both inclusive, when the reception period of the repeater is from 8 inclusive hours to 24 hours exclusive; (b) the transmission periods of the transmitters are set to from 2.0×n seconds to 400×n seconds, both inclusive, when the reception period of the repeater is from 3 hours inclusive to 8 hours exclusive; (c) the transmission periods of the transmitters are set to from 1.0×n seconds to 250×n seconds, both inclusive, when the reception period of the repeater is from 1 hour inclusive to 3 hours exclusive; and (d) the transmission periods of the transmitters are set to from 0.02×n seconds to 150×n seconds, both inclusive, when the reception period of the repeater is from 1 second inclusive to 1 hour exclusive.

4. The communication system according to claim 3, wherein either the first batteries or the second battery is/are environmental generator(s).

5. A communication system comprising:
at least one transmitter including a first battery and configured to transmit radio waves with a prescribed transmission period;
a repeater including a second battery and configured to receive the radio waves transmitted by the at least one transmitter with a reception period;
a first measuring circuit configured to measure a power consumption of the at least one transmitter in a prescribed time;
a second measuring circuit configured to measure a power consumption of the repeater; and
a control circuit configured to change the reception period based on the power consumptions as measured by the first measuring circuit and the second measuring circuit.

6. A repeater configured to receive the radio waves transmitted by the at least one transmitter with the reception period set by the method according to claim 1.
